(19) United States
(12) Patent Application Publication
(10) Pub. No.: US 2004/0020694 A1
(43) Pub. Date: Feb. 5, 2004

(54) In-bed human weighing device

(76) Inventors: Steven Ronald Hall, Wales, MA (US); Janet Claire Hall, Wales, MA (US)

Correspondence Address: Steven R. Hall, 24 Woodland Heights, Wales, MA, 01081, US

(21) Appl. No.: 10/210,580

(22) Filed: Aug. 1, 2002

(51) Int. Cl. G01G 19/52; G01G 19/02

(52) U.S. Cl. 177/144; 177/146

(57) ABSTRACT

An apparatus which provides a portable means for a caregiver with limited strength to easily weigh patients in bed who are, unable or unwilling to get out of bed, or very heavy and too large for conventional scales. It works on low beds with very little underside clearance, beds without wheels, and in rooms with limited space. The apparatus includes a weight readout indicator and several lightweight weight sensing lifting assemblies each of which having a vertically adjustable cam type bed frame lifter and a load cell. When the bed frame lifter is placed under a bed frame, adjusted up to the underside of the frame, and rotated to its thickest point, a portion of the bed is lifted. This is repeated until the entire bed is lifted. The weight of the bed on the lifters induces the load cells sending a signal to the weight readout indicator.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of medical scales, and more specifically is a device to weigh bed-ridden and very heavy patients.

It is widely known that good healthcare practice includes periodic weight monitoring. Proper nutrition and diet is essential to an enhanced quality of life, even for those who cannot easily leave the bed they are in. The best way for healthcare professionals to measure the effects of implemented long term nutritional and diet programs, and the health of those they care for, is through periodic weight monitoring. Unfortunately, due to limiting factors of current scales, many patients today are not receiving proper weight monitoring.

In Long Term Care Skilled Nursing Facilities, hospitals, Assisted Living Facilities and with Home Heath Care Agencies the need exists for a durable, lightweight, small and easily transportable bed scale to weigh their bed-ridden patients. This scale should be small enough to fit into a small or crowded room so often seen in these settings. It should fit all types of beds, including beds without wheels, and beds with very low underside clearance. The need also exists for an affordable scale to weigh extremely heavy patients. It is not uncommon for a patient to weigh as much as 500 to 800 pounds or more at times. Many of the conventional scales used at these facilities do not have the capability to weigh a person this heavy. It is also more likely that someone this heavy would be bed-ridden.

In these budget restraining times, many of healthcare facilities and agencies cannot afford to purchase several different scales to weigh their bed-ridden patients. Some of these patients may be in a bed without wheels or with very little underside clearance or they may be too heavy for conventional scales. Because of varying limitations of present scales, the need exist for an affordable device that one person can use the same device to quickly weigh several different patients in their beds.

In the not too distant past, the only accepted portable method of weighing bed-ridden patients was to lift them up using an engine hoist type device like Brainerd, Jr. et al. U.S. Pat. No. 5,033,563 Jul. 23, 1991 which lifts the patient to weigh them in the same manner fish or produce are weighed. This can be quite frightening for many, and painful for the frail arthritic patient, as many healthcare professionals can attest to. This engine hoist type device cannot be used if the patient has fractures or is extremely heavy. It is also very large and cumbersome. Stultz et al. U.S. Pat. No. 4,006,789 Feb. 8, 1977 and Hay et al. U.S. Pat. No. 5,319,817 Jun. 14, 1994 lift a patient with a stretcher type scale. Stultz U.S. Pat. No. 4,006,789 being very large and cumbersome like the engine hoist type U.S. Pat. No. 5,033,563. On all three of these It is necessary for the caregiver to slide or roll the patient to place them onto the weighing apparatus which puts the caregiver at risk for back and other related strain injuries.

Swersey et al. U.S. Pat. No. 4,281,730 and Haggstrom U.S. Pat. No. 5,086,856 describe portable bed scales that weigh both the bed and the patient. Both of these require the healthcare provider to place the weight monitoring devices at each wheel and roll the bed, with the bed-ridden patient in it, onto the weight measuring devices. This is not an easy task for one person, nor is it safe or practical, as the healthcare provider also runs the risk of serious back or related strain injury.

Lohkamp U.S. Pat. No. 6,380,496 Apr. 30, 2002 lifts and weighs a bed with the patient in it by the use of 4 portable wheel lifts at each corner of the bed. Our scale appears to use fewer and less expensive strain gage load cells than this one, allowing for a more affordable scale. The patent states that this device is for a wheeled bed only, and appear to not be able to easily weigh a bed without wheels such as a bed normally seen in an Assisted Living or Home Care setting.

Ashpes et al. U.S. Pat. No. 5,990,423 Nov. 23, 1999 and Neuman U.S. Pat. No. 5,747,745 May 5, 1998 both lift and weigh a bed and patient by lifting the frame of the bed. Neuman U.S. Pat. No. 5,747,745 speaks of “attaching to a bed frame”, it appears to be more of a permanent retrofit, limit it's portability and making it difficult for a caregiver to weigh several patients with the same device. Ashpes U.S. Pat. No. 5,990,423 is large and requires the entire unit to be rolled under a bed which may be difficult in a Long Term or Home Care Setting because of the very small and crowded rooms so often seen in these settings. It also appears that this device cannot be used with what are called “low beds”, which have very little underneath clearance, often used in Long Term Care Facilities.

Our device is small, very portable and easily transportable. It is capable of lifting very heavy people up to at least 800 pounds or more, which doesn't appear to be addressed in earlier patents. One person can quickly and easily weigh several bed-ridden patients using the same scale. It lifts at the frame rails so wheel size or lack of wheels is not a problem and seems to have none of the limitations that prior attempts at solving this problem have.

### BRIEF SUMMARY OF THE INVENTION

An object of the invention is to provide a reliable, portable and affordable device so one caregiver can quickly weigh several patients in-bed using the same device.

An object of the invention is to provide a means to weigh a bed-ridden patients, who may be severely injured or extremely ill, without disturbing them unnecessarily.

An object of the invention is to provide a means to weigh extremely heavy patients in their beds.

An object of the invention is to provide an economical and portable means to easily weigh all bed-ridden patients, regardless of bed type or size.

An object of the invention is to provide a means to weigh patients who refuse to get out of bed to be weighed.

An object of the invention is to provide a portable means for a caregiver to weigh a patient in bed in a small crowded room, regardless of bed type or size.

An object of the invention is to provide a portable means for a caregiver to weigh a patient in bed that requires very little strength to operate.

An object of the invention is to provide a means to weigh a patient in bed that will keep a caregiver safe from back or strain injury.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a Portable In-Bed Patient Weighing Device comprising of a weight readout indicator connected to a plurality of weight sensing lifting assemblies by means of data cables or wireless communication. Each weight sensing lifting assembly comprises of a vertically adjustable cam type bed frame lifter connected to a load cell. When the bed frame lifter is adjusted up to the bottom of a bed frame and rotated to its thickest point, a portion of the bed frame is lifted. This process is repeated for all the lifting assemblies until the entire bed is lifted. The weight of the bed and patient on the lifters and the corresponding load cells, induces the load cells sending a signal to the weight readout indicator.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an exploded view of the invention showing only a partial view of the base (26).

FIG. 2 is a front view of the weight sensing lifting assembly (10) with the protective cover (20) removed.

FIG. 3 is a side view showing the range of vertical adjustment of the weight sensing lifting assembly (10).

FIG. 4 is a side view showing the weight sensing lifting assembly (10) ready to lift a portion of a bed frame (38).

FIG. 5 is a side view showing the weight sensing lifting assembly (10) lifting a portion of the bed frame (38).

FIGS. 6A and 6C are front views showing the bed frame lifter (18) in a resting position.

FIG. 6B is a front view showing the bed frame lifter's (18) position when the bed frame is lifted.

FIG. 7 is a block diagram showing the relationship of the load cells (14) to the weight readout indicator (12).

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

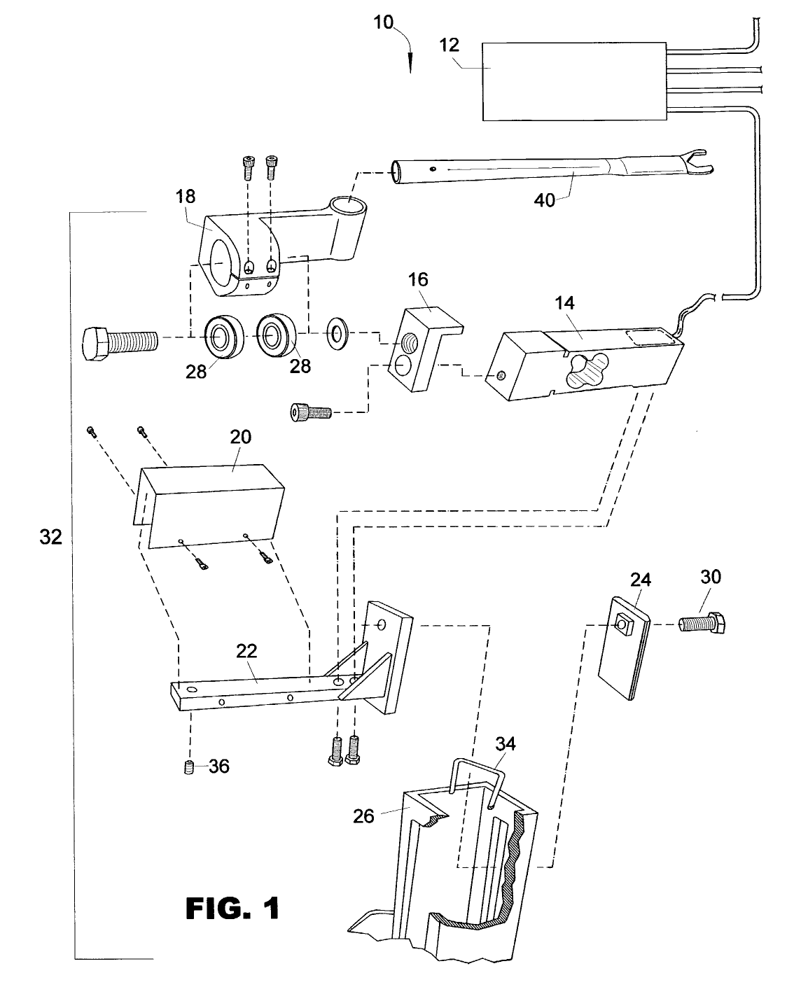

In accordance with an important feature of the present invention, there is shown in FIG. 1 an exploded view of the portable weight measuring device (10) for weighing several non-ambulatory or very heavy humans in their beds, without disturbing them, regardless of bed type or size, using the same weight measuring device.

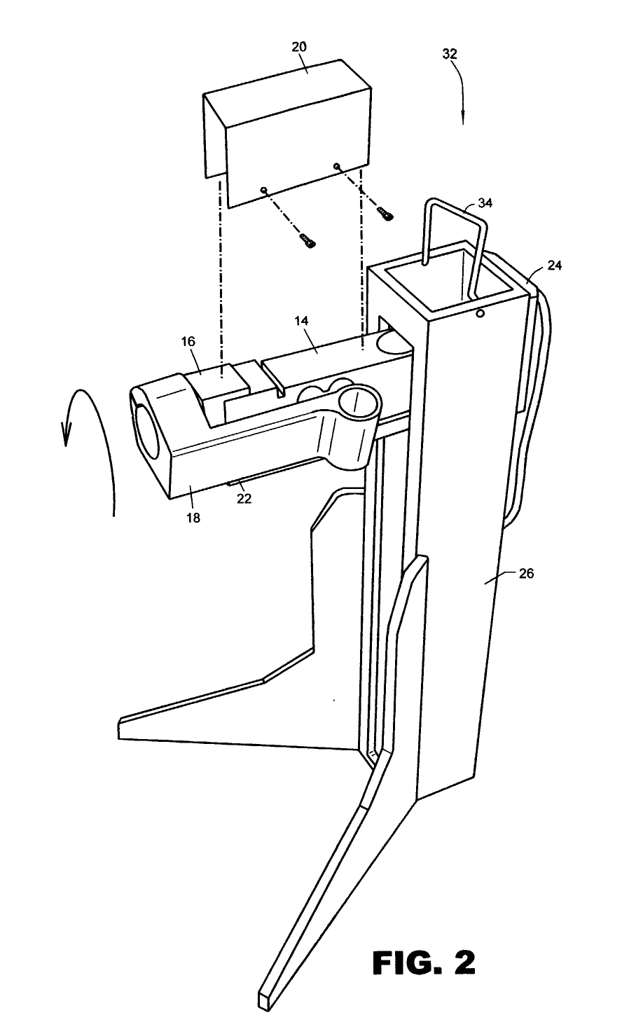

The invention is comprised of a weight indicator readout (12) and more than one weight sensing lifting assemblies (32). FIG. 2 shows the same weight sensing lifting assembly (32) assembled with the load cell guard (20) removed. The weight sensing lifting assemblies (32) in FIG. 1 includes, a base (26), a vertically adjustable load cell holder (22). This load cell holder (22) is attached to the base (26) which has a vertical slot in the back, using a hollowed center locking fastener (30) which passes through the holding plate (24) that is held into a slot and on the back of the base (26) using the hollowed center locking fastener (30). The hollowed center locking fastener (30) has a hole through the center in which the load cell (14) data cable (32) passes. The load cell is protected with a guard (20) and a load cell overload stop (36). Shown is an optional connecting bracket (16), bearings (28), a cam style bed frame lifter (18), and a carrying handle (34).

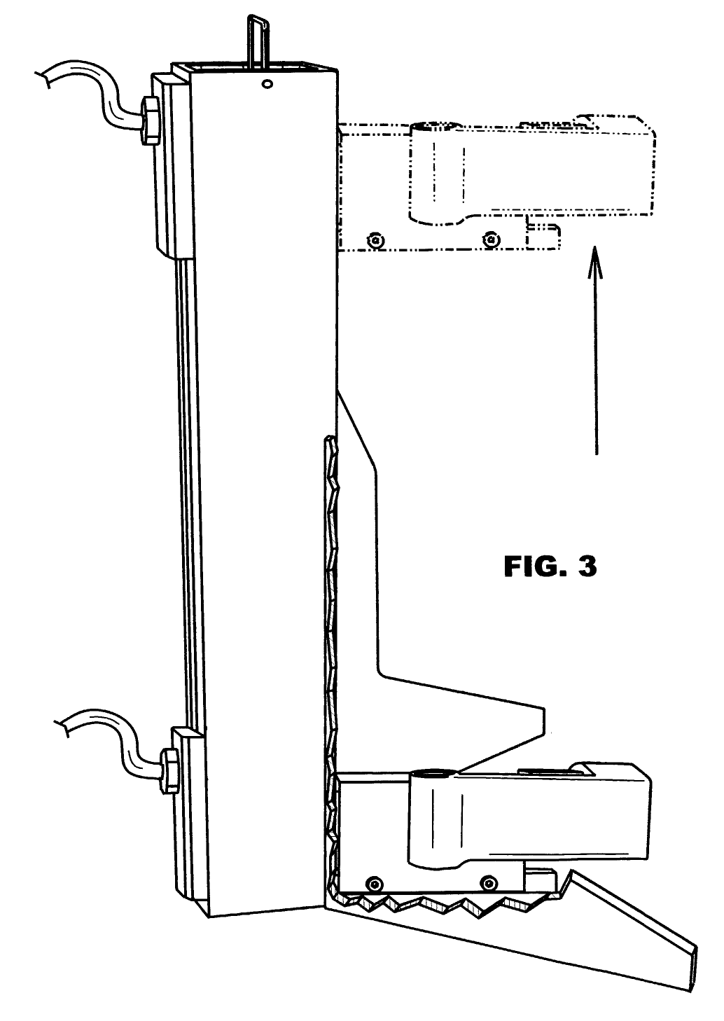

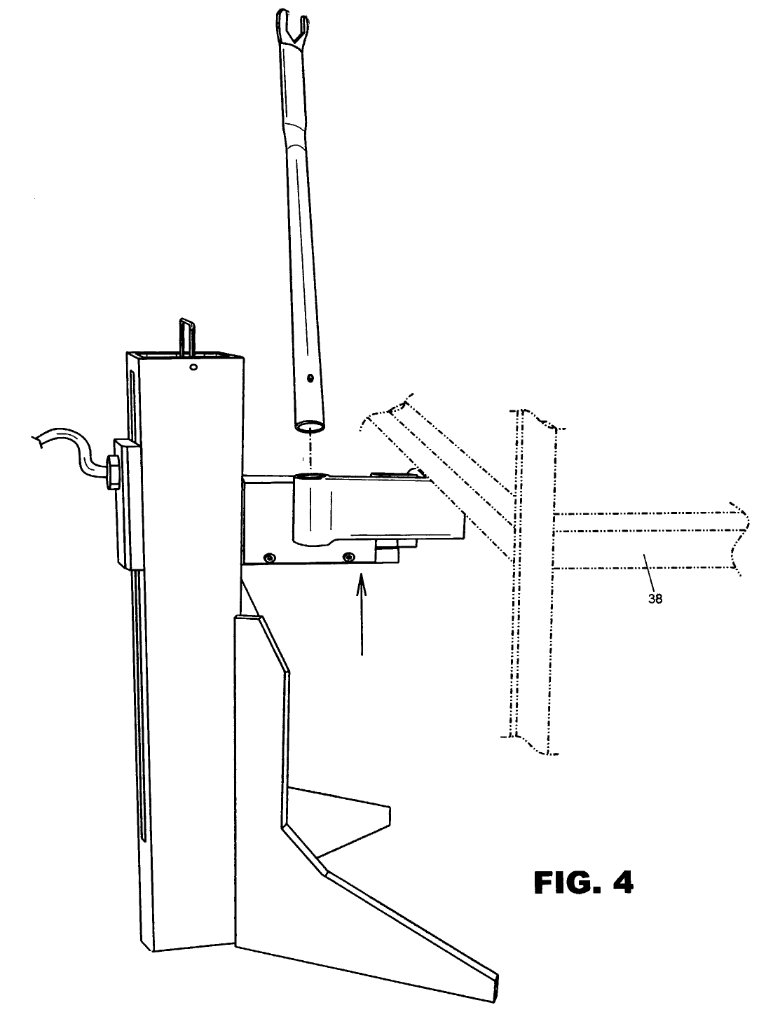

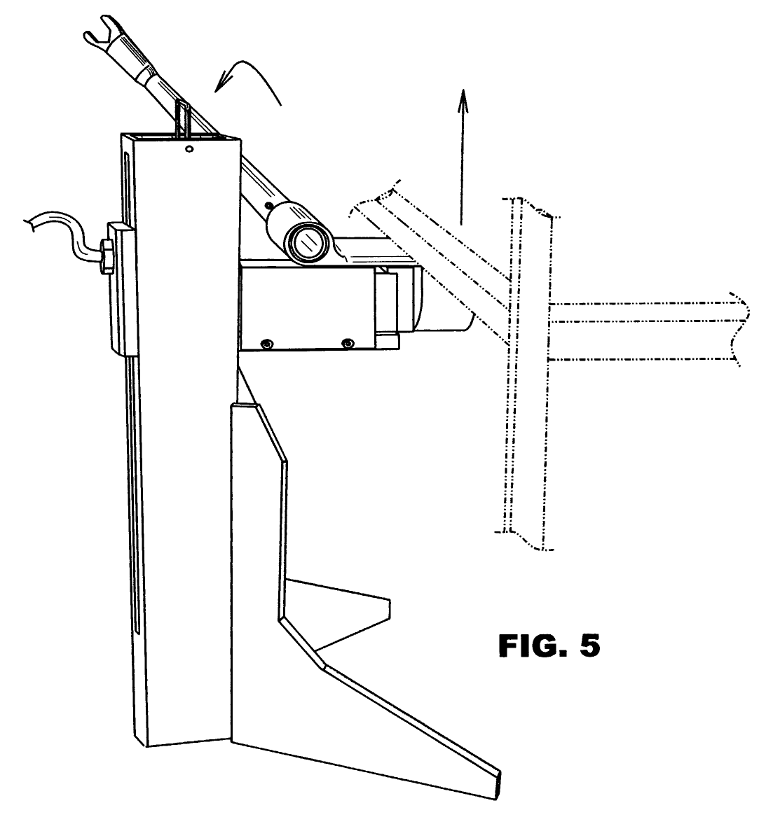

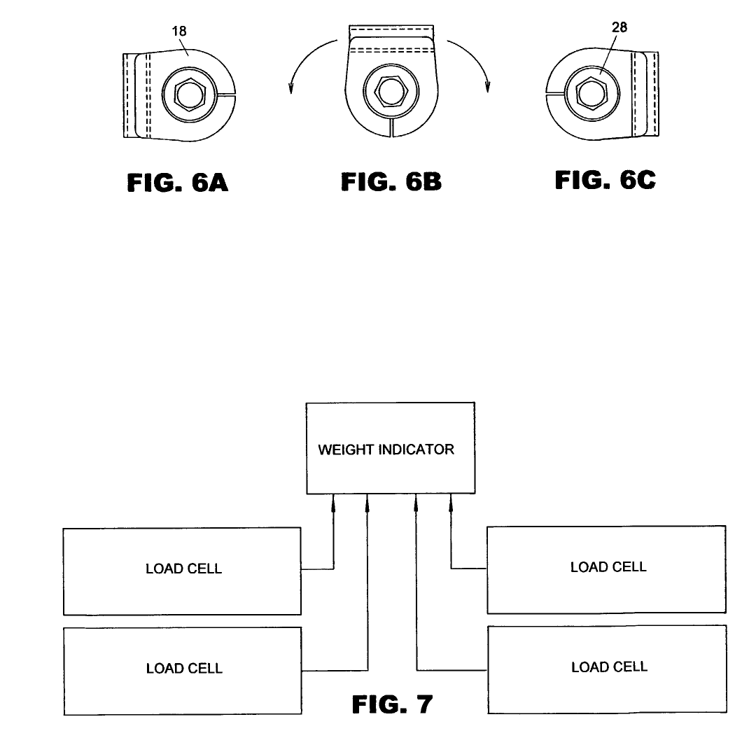

FIG. 3 shows the adjustability of the complete assembly (32) for various height bed frames. Referring to FIG. 4 shows the setup for preparation to lift up a portion of a bed with the back of an assembly (32) facing out at preferably the side of the bed and nearest a corner. The hollowed center locking fastener (30) is loosened using lever/wrench combo (40). By gripping the holding plate (24) and the bottom of the adjustable load cell holder (22), the unit is slid up until the bed frame lifter (18), in a resting position (see FIGS. 6a and 6c), makes contact with the underside of the bed frame (38). The fastener (30) is locked with the lever/wrench combo (40) and the round end of lever/wrench combo (40) is inserted into the hollow end of the bed frame lifter (18) opposite the bearing side as shown. Refer to FIG. 5 where the bed frame lifter (18) is rotated to its thickest point which has a large flat to hold it in place at this position (see FIG. 6c) using the lever/wrench combo (40). This portion of the bed frame (38) is lifted off the floor. The lifting procedure is repeated at each corner of the bed until the entire bed is off the floor.

The weight of the bed frame (38) on the frame lifter (18) which is slotted on one

The weight of the bed frame (38) on the frame lifter (18) which is slofted on one side where it clamps around the bearings (28) which are connected with a fastener to the load cell (14) directly or using the optional bracket, (16) induces the load cell (14), sending a signal to the weight readout indicator (12). The weight readout indicator (12) senses the combined gross weight on all the load cells (14) when all are induced.

The weight of a person in-bed is determined by first weighing the bed or a similar bed unoccupied. The weight of the unoccupied bed is recorded. The person and bed are then weighed. The gross weight of the patient and bed is then determined, wherein the predetermined weight of the bed is subtracted, either automatically or manually, leaving the net weight of the human.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1) A portable in-bed human weighing device comprising of:
(a) a weight readout indicator, and
(b) a plurality of portable weight sensing lifting assemblies, each comprising of:
(1) a base,
(2) a load cell to determine the weight of an applied load, and
(3) a bed frame lifting apparatus;
whereby when sufficient amount of said plurality of said weight sensing lifting assemblies are positioned under a bed frame and all are activated as to elevate said human's entire bed off of a surface, so as combined weight of said human and said bed is sensed and transmitted to said weight readout indicator.

2) the portable weight sensing lifting assembly of claim 1b comprising of a bed frame lifter, said bed frame lifter is adjustable up or down to adjust to different height bed frames.

3) the weight sensing lifting assembly of claim 1b comprising of a bed frame lifter, said bed frame lifter is cam type, said bed frame lifter being rotated by a means to its thickest point, lifts a portion of said bed frame.

4) the portable weight sensing lifting assembly of claim 1b comprising of a bed frame lifter, said bed frame lifter lifts a portion of the bed, by a means, when activated, at the underside of the bed frame rails.

5) the portable weight sensing lifting assembly of claim 1b, being slid under said bed frame, so as said bed frame lifter is directly under the bed frame and adjusted up to touch underside of the bed frame, then activated by a means to lift a portion of bed frame, thus applying a load by a means onto said load cell.

6) the plurality of said portable weight sensing lifting assemblies of claim 1b, each having a load cell which connect to said weight readout indicator by means of data cables.

7) the weight indicator of claim 1a, displays the combined sensed weight thru data transmission, as indicated by the plurality of said weight sensing lifting assemblies and their respective load cells, when a weight is applied onto said load cells and all are induced.

8) a portable in-bed human weighing device comprising of:
(a) a plurality of portable weight sensing lifting assemblies, wherein when sufficient amount of said plurality of said portable weight sensing lifting assemblies are positioned under said bed's frame and all are activated as to elevate said bed off of a surface, thereby inducing each attached load cell, so as the combined weight of said human and said bed can be sensed and transmitted to,
(b) a weight readout indicator, wherein said weight readout indicator subtracts from the gross weight a previously determined weight of the unoccupied bed thereby displaying the net weight of said human.

9) said weight readout indicator of claim 8 receives data through wireless communication.

10) a portable in-bed human weighing device comprising of:
(a) a weight readout indicator, and
(b) a plurality of portable weight sensing lifting assemblies, wherein designed so each is placed toward the outside of a bed, but under said bed frame, thereby lifting said bed by means of said frame, whereby providing an easy portable means to weigh a human in a bed which may not have wheels, and, or clearance under said bed, without having to lift or move said human.
